(19) United States
(12) Patent Application Publication
(10) Pub. No.: US 2018/0043230 A1
(43) Pub. Date: Feb. 15, 2018

(54) VERSATILE BATTING TEE ADAPTER

(71) Applicant: PORFIRIO A. GUTIERREZ, METUCHEN, NJ (US)

(72) Inventor: PORFIRIO A. GUTIERREZ, METUCHEN, NJ (US)

(21) Appl. No.: 15/674,030

(22) Filed: Aug. 10, 2017

Related U.S. Application Data
(60) Provisional application No. 62/372,938, filed on Aug. 10, 2016.

(51) Int. Cl. A63B 69/00; B29C 45/00

(52) U.S. Cl. CPC A63B 69/0075; B29C 45/006; A63B 2069/0008; A63B 2209/00; A63B 2225/093; A63B 2102/18

(57) ABSTRACT

A versatile adapter for a ball batting tee having a housing that has a top end that has a plurality of bristles embedded on its top surface; a mid-body section that has a plurality of equidistantly spaced and outwardly projected vertical ridges; and a tapered bottom end that has a plurality of equidistantly spaced and outwardly projected annular ridges. The adapter is configured to be removably inserted into a circular opening on the top end of a supporting rod of a batting tee and once inserted, the adapter is securely held in the circular opening by friction.

### CLAIM OF PRIORITY

This non-provisional application claims priority to U.S. provisional application 62/372,938 filed on Aug. 10, 2016, the contents of which is fully incorporated by reference in its entirety.

### FIELD OF THE EMBODIMENTS

This field of the embodiments of the present invention relate to an adapter for a batting tee used by a player practicing the hitting of a ball, and more specifically, to a versatile adapter capable of being inserted into a batting tee of different apertures, as well as to a structure of attaching the adapter to the batting tee.

### BACKGROUND OF THE EMBODIMENTS

In a ball game, such as baseball or softball, the task of the batter is to hit the ball, thrown by the pitcher, over the home plate with a ball bat. The batter may need to use different batting strategies which employ different swinging and hitting mechanics. Therefore, the batter needs to be properly trained in practices ahead of the game in order to master various proper batting techniques and mechanics. In real games, the batter can apply these different techniques and mechanics to improve his/her game playing. A batting practice tee is used in such trainings, which typically includes a base with a vertical pole attached. The pole typically contains a height adjustment mechanism and its upper portion is equipped with a soft stem with a cup-shaped ball holder attached on the top. The soft upper portion is typically made of spongy/resilient materials for supporting the ball via the ball holder and for the ability of this upper portion to swing back and forth after the player hits the ball and to eventually return to its original upright position.

However, the aforementioned conventional batting tee set-up cannot always offer accurate simulation of the hit effect in a real game as needed for the trainings. For example, if the batter tries to hit the ball placed on a conventional batting tee set-up from a lower position, the bat may touch the stem or the ball holding cup before hitting the ball. This will either cause the ball jumping and falling out from the ball holder, or the shifting of the ball trajectory path from intended. Alternatively, if the batting tee set-up is too low (as compared to the height of bat-swing by the batter), or if the batter tries to hit the ball from above, the ball may endure more friction between the ball holder and the ball due to the hitting force coming from above, which will also cause shifting in the ball's trajectory path. Similarly, as this type of batting tee set-up tends to rely, in part, on the bending of the soft rod, when hit, to help throw the ball, the same friction between the ball holder and the ball will lead to undesirable trajectory path of ball.

There have been various prior attempts to improve on the aforementioned conventional batting tee set-up. Examples of such related art are described below:

U.S. Pat. No. 8,992,348 pertains to a swing training device that has an upright vertical support which is height-adjustable and multiple training attachments for working on a batter's different skill sets. The attachments include a regular batting tee, a “cast away” batting tee, an “in and out” batting tee, and a “perfect cut” batting tee. Each tee is interchangeable with the others, each being used with the vertical support.

U.S. Pat. No. 6,413,175 pertains to a batting tee in which the mount for the ball is positioned lower than the other components of the batting tee to encourage a level swing at the ball and to protect the mount from damage from the impact of a bat. The batting tee includes a base, an upright, and a swing arm, the mount for the ball being integral with the end of the swing arm opposite the end mounted to the upright. The swing arm is preferably pivotally and telescopically received in the upright so that the position of the ball can be varied.

U.S. Patent Application No. 2011/0092317 pertains to a training system for baseball and softball batters containing but not limited to a manually operated mobile batting tee and an illustrated board on which the tee is maneuvered. The operator is positioned at the opposite end of the board from home plate. The device is operated by placing a ball on the bristled head and using the adjustable handle to push the mobile tee to marked locations where the ball is then hit by the batter. After the ball is struck the operator pulls the tee back to its original location where another ball is loaded and the cycle is repeated. Ball elevation is adjusted by releasing the tension device and moving the stem up or down.

None of the art described above addresses all of the issues that the present invention does. Accordingly, it is imperative, as there is an unmet need, to provide a batting practice tee to alleviate the aforementioned problems faced by the hitter using a conventional batting practice tee. The solution to be provided should be versatile enough to accommodate batting tees of various sizes as they are available in different ball fields, as well as being capable of reducing the contact surface when for supporting the ball which is less likely to be damaged by the impact of a bat and positions the ball in the hitter's hitting zone and teaches a proper swing. An adequate solution to this unmet need should also be easy to implement, employ a minimal number of parts and be easy to use.

### SUMMARY OF THE EMBODIMENTS

The present invention has been made to overcome the above-mentioned drawbacks of conventional batting tee ball holder. In one of the embodiments, the present invention provides: an adapter for a ball batting tee, which comprises a housing that has a top end that has a plurality of bristles embedded on its top surface; a mid-body section that has a plurality of equidistantly spaced and outwardly projected vertical ridges thereon; and a tapered bottom end that has a plurality of equidistantly spaced and outwardly projected annular ridges thereon. The cross-sections of said outwardly projected ridges on the mid-body section or the tapered bottom end are, independently, rectangular, triangular or trapezoidal in shape and said bristles are distributed as two concentric rings with those on the outer ring taller than those in the inner ring. The adapter housing is formed in one piece by injection molding from a resilient material, which is selected from the group of polymer materials consisting of rubber, polyurethane, polychloroprene, neoprene, styrene butadiene (SBR), polyacrylics, and polyvinyl acetate (PVA), other kinds include polyvinyl chloride (PVC), PBT silk, polypropylene, polyester, silk, thunderon or Teflon®. The bristles may be made from the same or different materials.

In another of the embodiments, the present invention provides: an adapter for a ball batting tee, which comprises a housing that has a top end that has a receiving aperture and a disk-shaped insert configured to be inserted into the receiving aperture, where the insert comprises a plurality of bristles embedded in its top surface; a mid-body section that has a plurality of equidistantly spaced and outwardly projected vertical ridges thereon; and a tapered bottom end that has a plurality of equidistantly spaced and outwardly projected annular ridges thereon. The cross-sections of said outwardly projected ridges on the mid-body section or the tapered bottom end are, independently, rectangular, triangular or trapezoidal in shape and said bristles are distributed as two concentric rings with those on the outer ring taller than those in the inner ring.

In yet another of the embodiments, the present invention provides: a ball batting tee system, which comprises a supporting rod, wherein the top end of the supporting rod has a circular opening and a removable tee adapter configured to be inserted into said circular opening on the top end of said supporting rod. The tee adapter is securely held in said circular opening on the top end of said supporting rod by friction between the inner surface of said circular opening and the annular rings of the tapered bottom end of the adapter, or between the inner surface of said circular opening and the ridges on the surface of the mid-body section or the tapered bottom end of the adapter. The adapter comprises an adapter housing that has a top end, a mid-body section, and a tapered bottom end. The top end is constructed as one piece comprises a plurality of bristles embedded in the top surface of the top end and wherein the mid-body section of the adapter housing has a plurality of equidistantly spaced and outwardly projected vertical ridges on the surface, and wherein the tapered bottom end of the adapter housing has a plurality of equidistantly spaced and outwardly projected annular ridges on the surface. Alternatively, the top end is constructed as a two piece structure that comprises a receiving aperture, and a disk-shaped insert configured to be inserted into the receiving aperture on the top end of the housing, wherein said insert comprises a plurality of bristles embedded in the top surface of the disk-shaped insert and wherein the mid-body section of the adapter housing has a plurality of equidistantly spaced and outwardly projected vertical ridges on the surface, and wherein the tapered bottom end of the adapter housing has a plurality of equidistantly spaced and outwardly projected annular ridges on the surface.

It is yet another object of the present invention to provide solid tee adapter, wherein the ball holding mechanism is attached to an inner portion of the body structure. The ball holding mechanism can be attached using a bolt that threads through the length of the body structure.

It is an object of the present invention to provide a batting tee adapter and corresponding batting tee system that is simple, versatile and effective and inexpensive to manufacture. This is accomplished through the simple yet elegant design of the adapter of this invention and the proper selection of resilient materials to manufacture the adapter.

It is further an object of the present invention to provide a versatile batting tee adapter with resilient bristles to serve as the ball-holding mechanism can hold the ball with minimal contact surface so that the impact of the friction between the ball holding mechanism and the ball on the ball trajectory will be reduced during batting practice.

It is yet another object of the present invention to provide a cover, that can be attached using a snap-fit connection, a friction connection or a threaded connection at the bottom of the insert in order to protect the fastener end which attaches the ball-holding mechanism to the housing of the tee adapter.

It is still another object of the present invention to provide a versatile betting tee adapter to prevent damage to the bat, especially when it is swung not as level by a batter who is still learning to swing with a proper technique. This is accomplished by the use of resilient bristles to hold the ball. Another object of the bristles is that they can be tall enough, and flexible enough for a batter swinging a bat be capable of swinging through the bristles, without affecting the ball or the adapter, while still being capable of supporting the ball.

In addition to the foregoing, other objects, features, aspects and advantages of the present invention will be better comprehended through a careful reading of a detailed description provided herein below with appropriate reference to the accompanying drawings.

### BRIEF DESCRIPTION OF THE DRAWINGS

FIG. 1 shows a top perspective view of an embodiment of the present invention.

FIG. 2 shows a front view of an embodiment of the present invention.

FIG. 3 shows a left side view of an embodiment of the present invention.

FIG. 4 shows a back view of an embodiment of the present invention.

FIG. 5 shows a right side view of an embodiment of the present invention.

FIG. 6 shows a top view of an embodiment of the present invention.

FIG. 7 shows a bottom view of an embodiment of the present invention.

FIG. 8 shows a front view of an embodiment of the present invention in relation to a batting tee and a ball.

FIG. 9 shows a sectional view of an embodiment of the present invention with a hollow core.

FIG. 10 shows a sectional view of an embodiment of the present invention with a solid core.

FIG. 11 shows an embodiment of the present invention with taller bristles.

FIG. 12 shows an exploded view of an embodiment of the present invention.

FIG. 13 shows a side view of an embodiment of the invention with a protective cap.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

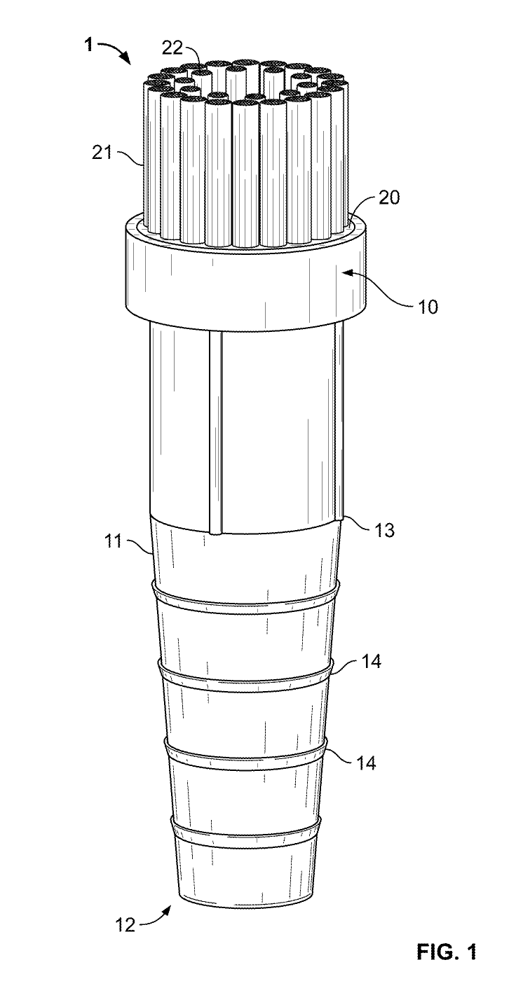

Referring now to FIG. 1, which shows a perspective view of an embodiment of the present invention of an adapter (1) for a ball batting tee, which comprises: a housing of a hollow body structure that has a top end (10), a mid-body section (11), and a tapered bottom end (12). The housing top end (10) comprises a brush-like structure of a plurality of upright standing resilient bristles (21 and 22) that are embedded into the top surface of the top end (10). In this embodiment, the upright standing resilient bristles (21 and 22) are intended to serve as a ball holder to support a ball placed on top of the bristles (21 and 22). Therefore, the resilient bristles (21 and 22) should be strong enough to support the ball placed on them while they can swing back and forth with one end attached to the top end (10). It is intended in this embodiment that the adapter housing is constructed in one piece.

In another of the embodiments of the present invention of an adapter (1) for a ball batting tee, the adapter comprises: a housing of a hollow body structure that has a top end (10), a mid-body section (11), and a tapered bottom end (12). The housing top end (10) has a receiving aperture for a disk-shaped insert (20) that is configured to be inserted into the receiving aperture. The disk-shaped insert (20) comprises a brush-like structure of a plurality of upright standing resilient bristles (21 and 22) that are embedded into the top surface of the insert (20).

In this embodiment, the upright standing resilient bristles (21 and 22) are intended to serve as a ball holder to support a ball placed on top of the bristles (21 and 22). Therefore, the resilient bristles (21 and 22) should be strong enough to support the ball placed on them while they can swing back and forth with one end attached to the disk-shaped insert (20). It is intended in this embodiment that the adapter housing is made into two sections with a disk-shaped insert (20) with a brush-like structure of a plurality of upright standing resilient bristles (21 and 22) embedded into its top surface as one piece and the rest of the housing as another piece.

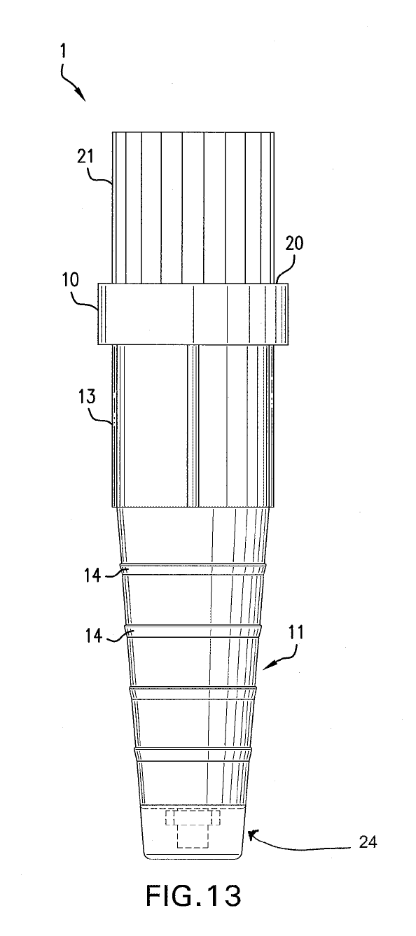

The insert (20) can be attached into the receiving aperture either by adhesives or through a threading structure constructed on both the outer side edge of the insert (20) and the inner side of the receiving aperture on the top end (10). Alternatively, the insert can be held in place using a fastener system (22), such as a bolt and nut, which spans the length of the adapter (11). As shown in FIG. 13, a cap (24) can be used to protect the fastener system (30), in case the adapter (11) falls from the tee. The cap (24) can be held in placed using a threaded connection, a snap-fit, or a friction connection. Alternatively the bristles (21 and 22) can be long enough such that if the batter does not make contact with the ball or with the adapter, the bristles will give way to the bat, ensuring that the adapter is not knocked over.

The mid-body section (11) of the adapter housing comprises a plurality of equidistantly spaced and outwardly projected vertical ridges (13) on its surface, which not only provide enhanced rigidity and structural support for the mid-section (11) of the hollow housing body, but also increase the frictional engagement between said mid-body section (11) and the batting tee, as needed.

Similarly, the tapered bottom end (12) of the adapter housing also comprises a plurality of equidistantly spaced and outwardly projected annular ridges (14) on the surface, again providing enhanced rigidity and structural support, as well as increasing the frictional engagement between said tapered bottom end (12) and the batting tee. Together with the adapter mid-body (11) with equidistantly spaced and outwardly projected vertical ridges (13) that is of a fixed outside diameter, the tapered bottom end (12) with a plurality of equidistantly spaced and outwardly projected annular ridges (14) of various outside diameters render the adapter of the present invention a versatile one that can accommodate batting tees of various sizes (with different inner diameters of the top aperture). In addition, the versatility of the adapter of the present invention is further defined by the ease of its use and its high portability, which is a reflection of its unique design and construction using resilient materials that are flexible, yet can sustain repeated hard impacts by the ball bat.

Typically, in one of the embodiments, the adapter housing (1), including its top end (10) with the upright standing resilient bristles (21 and 22); mid-body section (11); and tapered bottom end (12) are formed by injection molding as one piece. In another embodiment, the adapter housing (1), including its top end (10) with the receiving aperture; mid-body section (11); and tapered bottom end (12) are formed by injection molding as one piece, while the disk-like insert (20) with the upright standing resilient bristles (21 and 22) is formed by injection molding as another piece. The assembling of the two pieces can be achieved by attaching the insert (20) with the upright standing resilient bristles (21 and 22) into the receiving aperture in the top end (10) either by adhesives or through a threading structure constructed on both the outer side edge of the insert (20) and the inner side of the receiving aperture on the top end (10).

In one of the above embodiments, the entire adapter housing (1) is constructed in one piece of a resilient material. In another of the above embodiments, the adapter housing (1) and insert are constructed in two pieces and made of the same resilient material. In yet another of the above embodiments, the adapter housing and insert are constructed in two pieces and made of different resilient materials. At least one of the aforementioned resilient materials is selected from the group of polymer materials consisting of rubber, polyurethane, polychloroprene, neoprene, styrene butadiene (SBR), polyacrylics, and polyvinyl acetate (PVA), other kinds include polyvinyl chloride (PVC), PBT silk, polypropylene, polyester, silk, thunderon or Teflon®. Preferably, one or both of the adapter housing and insert are made of rubber.

In yet another embodiment, either one, or both, of the mid-body (11) and the tapered bottom end (12) of the adapter housing (1) can be constructed to not having a plurality of equidistantly spaced and outwardly projected vertical or annular ridges on the surface, but are constructed from resilient materials to further have a gripping surface of a high coefficient of friction, which will help to increase the frictional engagement between the batting tee and the mid-body section or the tapered bottom end.

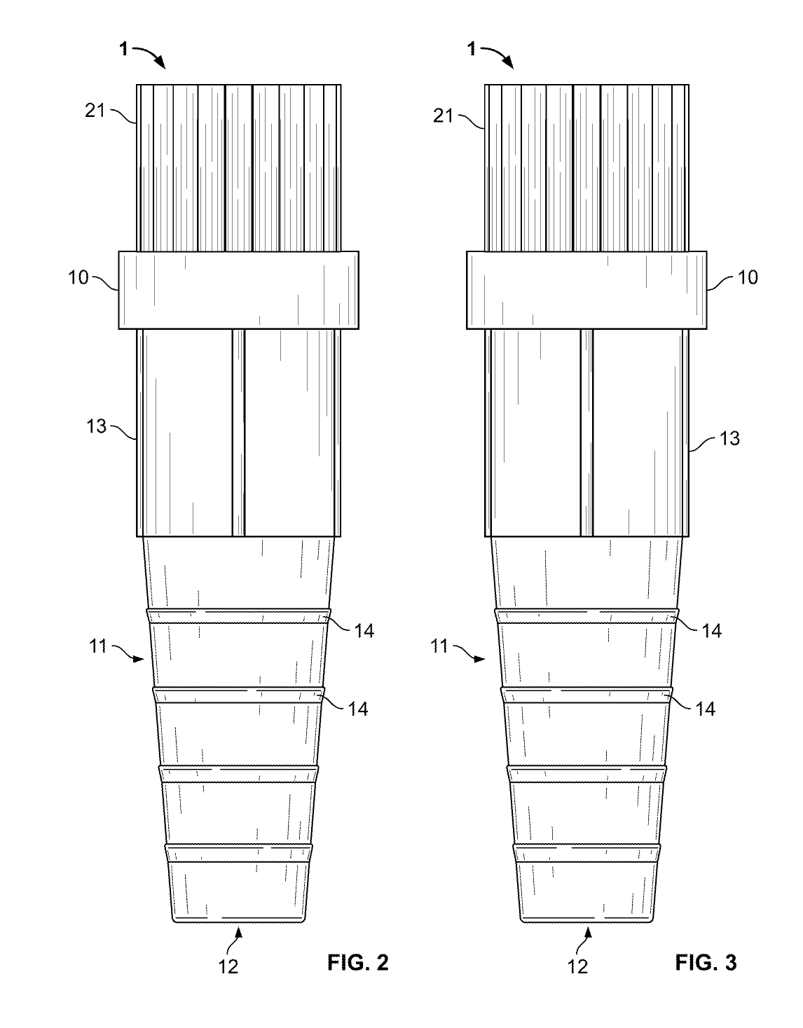

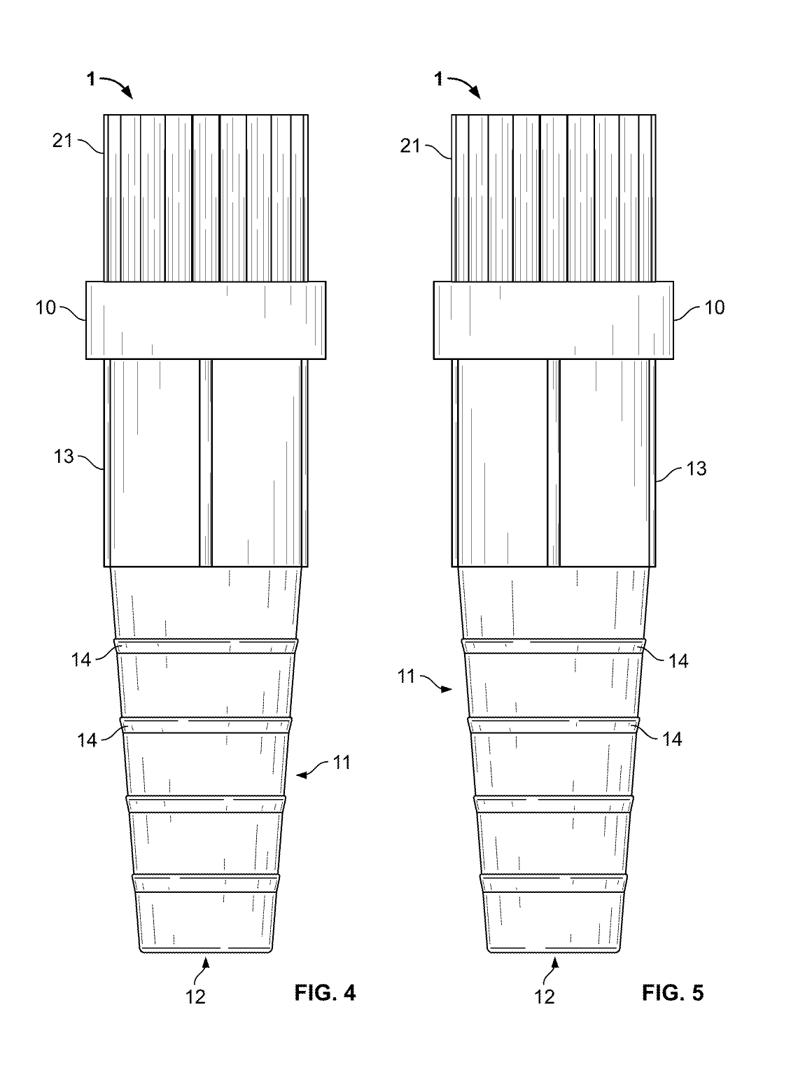

Referring now to FIGS. 2-5, which show four side-views of the aforementioned embodiment of the invention of the adapter (1) for a ball batting tee.

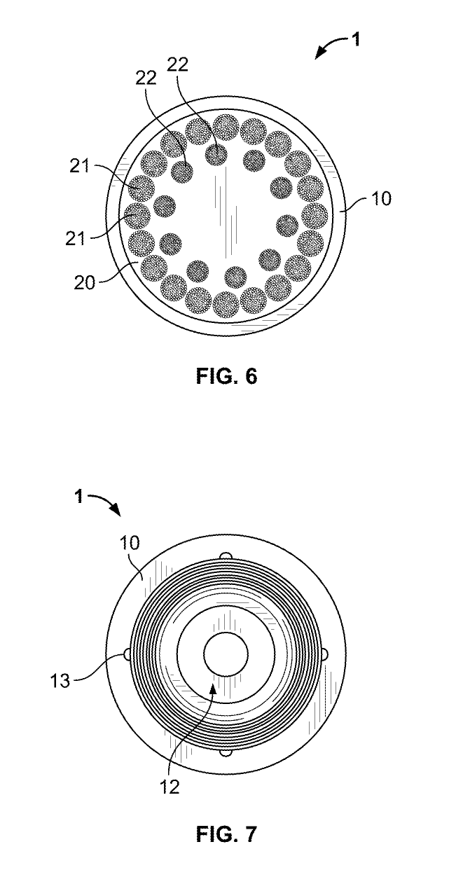

Referring now to FIG. 6, which shows a top view of the aforementioned embodiment of the invention of the adapter (1) for a ball batting tee. This view reveals the resulting relationship between the top end of the adapter housing (10) with a receiving aperture and the disk-shaped insert (20) that is inserted into the receiving aperture. Further as shown in FIG. 6, embedded into the top surface of the insert (20) are a plurality of resilient bristles (21 and 22), which are distributed as two concentric rings of bristle bundles. While there is no specific limitation as to the total number of bundles in each concentric rings and number of bristles in each bundle, there can be as many as 20-25 bundles of bristles (21) in the outside concentric ring and 15-20 bundles of bristles (22) in the inner concentric ring, with each bundle containing about 20 bristles.

Also as shown in FIGS. 1 and 6, the multiple bundles of bristles in the outer of the two concentric rings (21) that are embedded into the top surface of the top end (10) in one embodiment, or that of the insert (20) in another embodiment, are taller than the bundles of bristles in the inner ring (22) by about 1 mm to about 15 mm and more preferably about 3 mm. This unique feature of the arrangement of the bristles (21 and 22) and the height difference between the two concentric rings of bristle bundles (21 and 22), when coupled with the proper selection of suitable material(s) to construct the bristles, serve, on the one hand, to provide sufficient support for the ball that is placed on the two rings of bristles (21 and 22) while, on the other, not to cause too much friction between the ball and the tips of the bristles (21 and 22). Typically, the resilient bristles (21 and 22) are made from a polymer material which is selected from the group of materials consisting of nylon, PBT silk, polypropylene, polyester, silk, Thunderon or Teflon®. Preferably, the bristles are made of nylon, however, other suitable materials may be used.

Referring now to FIG. 7, which shows a bottom view of an embodiment of the present invention of the adapter (1) for a batting tee. In this view, the equidistantly spaced and outwardly projected annular ridges (14) on the surface of the tapered bottom end (12) appear as multiple concentric rings surrounding the bottom end (12), while the four equidistantly spaced and outwardly projected ridges (13) on the mid-body section (11) appear as four small protrusions on the top, bottom, left and right sides of the concentric ring of the largest diameter (representing the mid-body section (11).

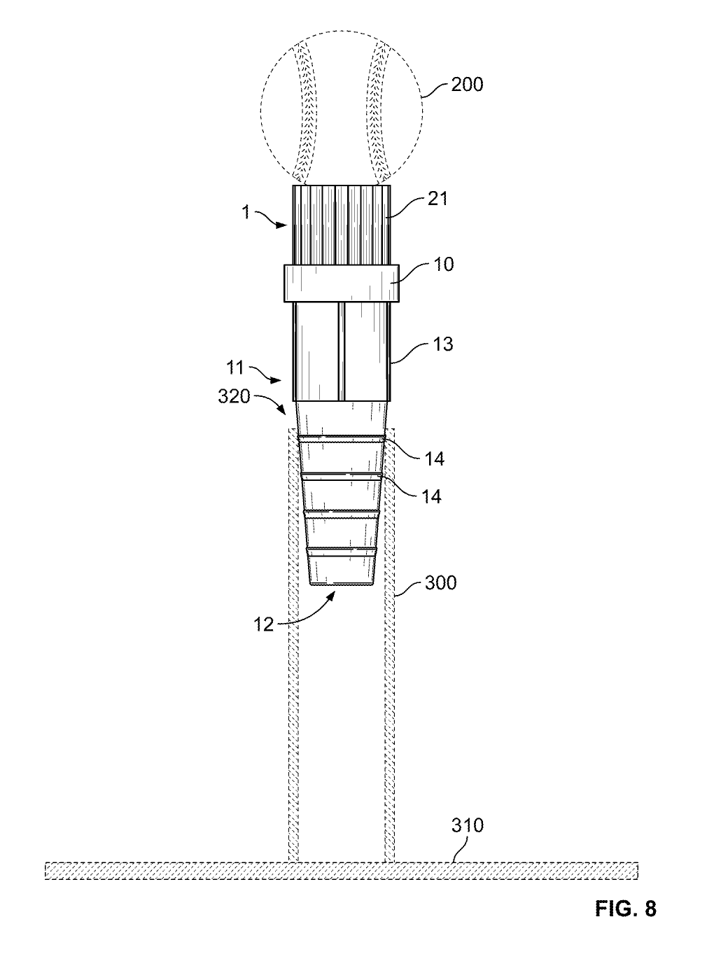

Referring now to FIG. 8, which shows a side view of an embodiment of the present invention of the ball batting tee system, which comprises a batting tee adapter (1) in relation to a batting tee (300) and a ball (200). Here, the batting tee adapter (1) comprises a housing that has a top end (10), a mid-body section (11), and a tapered bottom end (12), wherein the top end (10) is constructed as one piece comprises a plurality of bristles (21 and 22) embedded in the top surface of the top end (10) and wherein the mid-body section (11) of the adapter housing has a plurality of equidistantly spaced and outwardly projected vertical ridges (13) on the surface, and wherein the tapered bottom end (12) of the adapter housing has a plurality of equidistantly spaced and outwardly projected annular ridges (14) on the surface.

Alternatively, the top end is constructed as a two piece structure that comprises a receiving aperture, and a disk-shaped insert (20) configured to be inserted into the receiving aperture on the top end (10) of the housing, wherein said insert comprises a plurality of bristles (21 and 22) embedded in the top surface of the disk-shaped insert (20) and wherein the mid-body section (11) of the adapter housing has a plurality of equidistantly spaced and outwardly projected vertical ridges (13) on the surface, and wherein the tapered bottom end (12) of the adapter housing has a plurality of equidistantly spaced and outwardly projected annular ridges (14) on the surface.

Also shown in FIG. 8 is the ball batting tee (300) comprises a supporting rod (320, shown in a cross-sectional view) that is coupled to a top of a base (310), wherein at least the top end of the supporting rod (320) has a circular opening to accommodate the adapter (1) that is inserted into said circular opening of said supporting rod (320) and held by the friction between the annular ridges (14) on the tapered bottom end (12) of the adapter housing and the inner surface of the circular opening of said supporting rod (320). When the tapered bottom end (12) of the adapter housing is inserted, with a proper force, into the circular opening of the supporting rod (320) of the batting tee system (300), it causes a slight deforming of the tapered bottom end (12) of the adapter (1), such that one of the outwardly projected annular ridges (14) on the tapered bottom end (12), which is of a slightly larger outer diameter than the inner diameter of the circular opening on the top part of the supporting rod (320), is forced into the circular opening of said supporting rod (320).

Consequently, the tension force resulting from the deformed tapered bottom end (12) of the adapter housing trying to return to its original form helps to press the annular ridge (14) on the tapered bottom end (12) of the adapter housing against the inner surface of the circular opening of the supporting rod (320), thus increasing the friction between the two to hold the adapter firmly in place with the circular opening of said supporting rod (320). The versatility of the batting tee adapter (1) of the present invention in this embodiment is reflected by the fact that the batting tee adapter (1) of the present invention can be used with different supporting rods (320) of batting tee systems (300) having different circular opening sizes, of course to a limit.

In yet another embodiment of the present invention of a ball batting tee system, the batting tee adapter (1) is securely held in said circular opening on the top end of said supporting rod (320) by friction between the inner surface of said circular opening and the ridges (13) on the surface of the mid-body section (11) of the adapter (1). This embodiment is applicable to a situation where the inner diameter of said circular opening on the top end of the supporting rod (320) of the batting tee (300) is larger than the outer diameter of the largest of the plurality of equidistantly spaced and outwardly projected annular ridges (14) on the tapered bottom end (12) of the adapter housing, but not too large to have no contact between the inner surface of the circular opening on the top end of the supporting rod (320) and the outer surface of the plurality of equidistantly spaced and outwardly projected vertical ridges (13) on the mid-body section (11) of the adapter (1). Again, when enough of the mid-body section with these vertical ridges on the mid-body section (11) of the adapter (1) is inserted into the circular opening on the top end of the supporting rod (320), the friction between the inner surface of the circular opening on the top end of the supporting rod (320) and the outer surface of the vertical ridges (13) on the mid-body section (11) of the adapter (1) helps to hold the adapter in place in the batting tee system.

In both above embodiments of the present invention of a ball batting tee system, the batting tee adapter (1) of the present invention is removable from the supporting rod and the versatility of the batting tee adapter (1) in these embodiments is reflected by the fact that the batting tee adapter (1) of the present invention can be used with different supporting rods (320) of batting tees (300) having different circular opening sizes, which circular opening accommodates and holds the batting tee adapter (1) of the present invention by way of the friction between the inner surface of the circular opening of said supporting rod (320) and the outer surface of the plurality of equidistantly spaced and outwardly projected annular ridges (14) on the tapered bottom end (12) of the adapter housing (for smaller circular openings on the supporting rod 320), or the outer surface of the plurality of equidistantly spaced and outwardly projected vertical ridges (13) on the mid-body section (11) of the adapter housing (for larger circular openings on the supporting rod 320).

In yet another embodiment of the present invention of a ball batting tee system, the length of said supporting rod of the batting tee is adjustable through a mechanism on the supporting rod such that the height of the ball is correct with respect to the height of the player swinging the ball bat, where the height of the ball is defined by the height of the supporting rod (320) and the extent of the batting tee adapter (1) being inserted into the top circular opening on the supporting rod (320), which is, in turn, determined by the relationship between the inner diameter of circular opening on the supporting rod (320) and the outer diameters of the plurality of equidistantly spaced and outwardly projected annular ridges (14) on the tapered bottom end (12), or the plurality of equidistantly spaced and outwardly projected vertical ridges (13) on the mid-body section (11) of the batting tee adapter (1).

In sum, the versatility of the batting tee adapter (1) of the present invention is foremost defined by the ease of its use and its high portability, as well as its ability to accommodate batting tees (300) of various sizes, which is a reflection of the unique design of an adapter mid-body (11) with a plurality of equidistantly spaced and outwardly projected vertical ridges (13) that are of a fixed outside diameter and a tapered bottom end (12) with a plurality of equidistantly spaced and outwardly projected annular ridges (14) of various outside diameters.

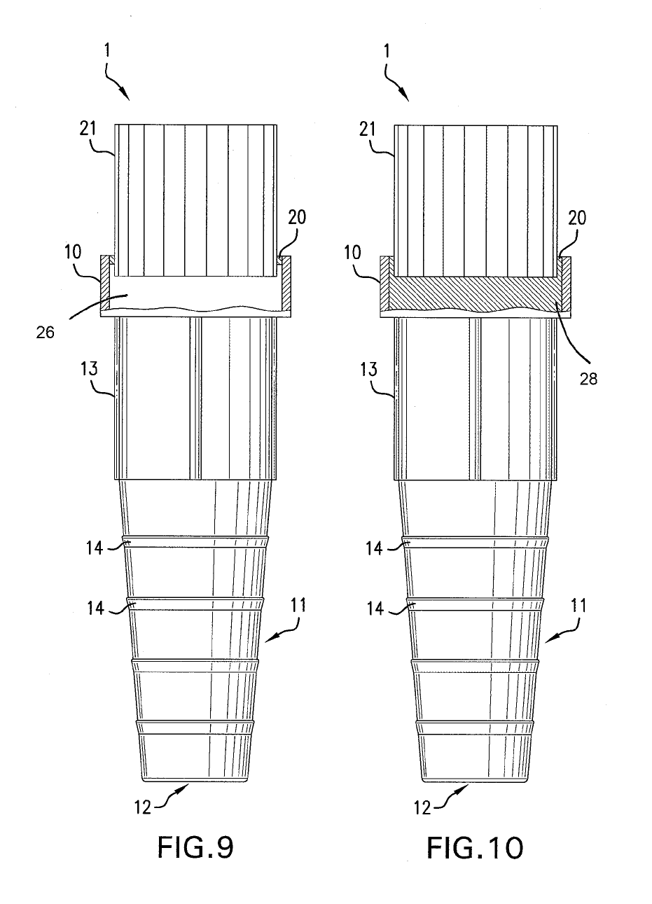

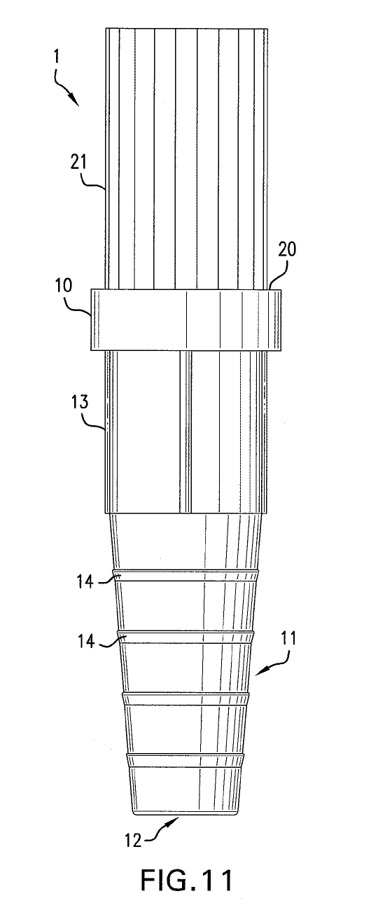

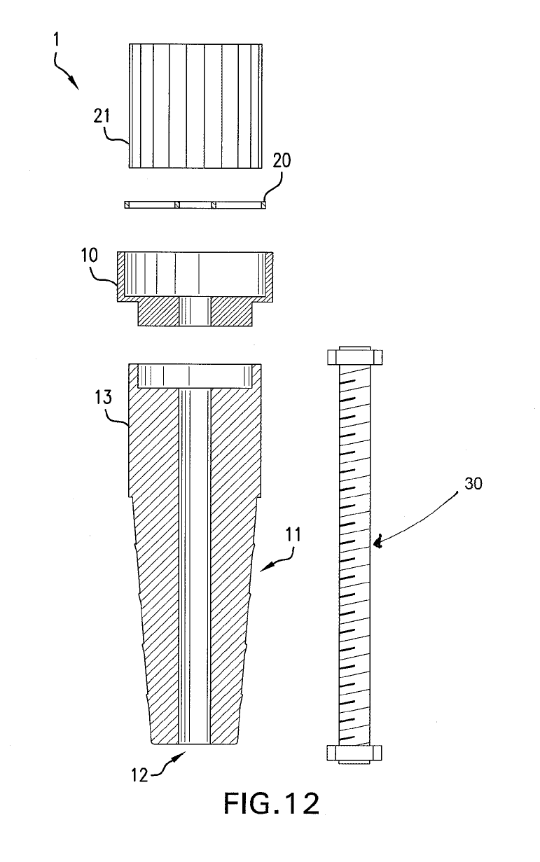

In FIG. 9, the sectional view offers a view of the hollow interior (26) of the batter tee adapter (1) and alternatively in FIG. 10, the sectional view offers a solid view (28) of the interior of the batter tee adapter (1).

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An adapter for a ball batting tee comprising:
a housing that has a top end, a mid-body section, and a tapered bottom end,
wherein the top end has a plurality of bristles embedded on the top surface;
wherein the mid-body section of the adapter housing has a plurality of equidistantly spaced and outwardly projected vertical ridges thereon; and
wherein the tapered bottom end of the adapter housing has a plurality of equidistantly spaced and outwardly projected annular ridges thereon.

2. The adapter according to claim 1, wherein the cross-section of said plurality of outwardly projected ridges on the mid-body section or the tapered bottom end are rectangular, triangular or trapezoidal in shape.

3. The adapter according to claim 1, wherein said plurality of bristles are distributed as two concentric rings on said top surface of the top end.

4. The adapter according to claim 3, wherein said plurality of bristles on the outer ring are taller than the plurality of bristles in the inner ring.

5. The adapter according to claim 1, wherein said adapter housing is formed by injection molding from a resilient material.

6. The adapter according to claim 5, wherein the resilient materials is selected from the group of polymer materials consisting of rubber, polyurethane, polychloroprene (better known as neoprene, styrene butadiene (SBR), polyacrylics, and polyvinyl acetate (PVA), and polyvinyl chloride (PVC) or a combination thereof.

7. The adapter according to claim 1, wherein said bristles are made from a material which is selected from the group consisting of nylon, PBT silk, polypropylene, polyester, or silk or a combination thereof.

8. An adapter for a ball batting tee comprising:
a housing that has a top end, a mid-body section, and a tapered bottom end, wherein the top end has a receiving aperture; and
a disk-shaped insert configured to be inserted into the receiving aperture on the top end of the housing, wherein said insert comprises a plurality of bristles embedded in the top surface of the insert;
wherein the mid-body section of the adapter housing has a plurality of equidistantly spaced and outwardly projected vertical ridges thereon; and
wherein the tapered bottom end of the adapter housing has a plurality of equidistantly spaced and outwardly projected annular ridges thereon.

9. The adapter according to claim 8, wherein the cross-section of said plurality of outwardly projected ridges on the mid-body section or the tapered bottom end are rectangular, triangular or trapezoidal in shape.

10. The adapter according to claim 8, wherein said plurality of bristles are distributed as two concentric rings on said top surface of said insert.

11. The adapter according to claim 10, wherein said plurality of bristles on the outer ring are taller than the plurality of bristles in the inner ring.

12. The adapter according to claim 8, wherein said housing and insert are formed by injection molding of the same resilient material, or different resilient materials.

13. A ball batting tee system, comprising:
a supporting rod, wherein the top end of the supporting rod has a circular opening; and
a tee adapter configured to be inserted into said circular opening on the top end of said supporting rod comprising,
an adapter housing that has a top end, a mid-body section, and a tapered bottom end, wherein the top end comprises:
i) a receiving aperture, and a disk-shaped insert configured to be inserted into the receiving aperture on the top end of the housing, wherein said insert comprises a plurality of bristles embedded in the top surface of the disk-shaped insert and wherein the mid-body section of the adapter housing has a plurality of equidistantly spaced and outwardly projected vertical ridges on the surface, and wherein the tapered bottom end of the adapter housing has a plurality of equidistantly spaced and outwardly projected annular ridges on the surface; or
ii) a plurality of bristles embedded in the top surface of the top end and wherein the mid-body section of the adapter housing has a plurality of equidistantly spaced and outwardly projected vertical ridges on the surface, and wherein the tapered bottom end of the adapter housing has a plurality of equidistantly spaced and outwardly projected annular ridges on the surface.

14. The ball batting tee system according to claim 13, wherein the tee adapter is removable from the supporting rod.

15. The ball batting tee system according to claim 13, wherein the tee adapter is securely held in said circular opening on the top end of said supporting rod by friction between the inner surface of said circular opening and the annular rings of the tapered bottom end of the adapter, or between the inner surface of said circular opening and the ridges on the surface of the mid-body section or the tapered bottom end of the adapter.

16. The adapter of claim 1, wherein the housing further comprises a hollow inner cavity.

17. The adapter of claim 1, wherein the housing further comprises a solid core.

18. The adapter of claim 8, wherein the disk-shaped insert is coupled to the housing via a fastener.

19. The adapter of claim 19, wherein the fastener is covered by a protective cap.

20. The ball batting tee system according to claim 13, wherein the tee a disk-shaped insert is coupled to the tee adapter using a fastener.
